(19) United States
(12) Patent Application Publication
(10) Pub. No.: US 2006/0150121 A1
(43) Pub. Date: Jul. 6, 2006

(54) Mobile communication terminal and method for improving user convenience using a light unit

(75) Inventor: Won-Bae Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/299,547

(22) Filed: Dec. 12, 2005

(30) Foreign Application Priority Data
Dec. 22, 2004 (KR) 110742/2004

(51) Int. Cl. G06F 17/00; G06F 3/00

(52) U.S. Cl. 715/827

(57) ABSTRACT

A mobile communication terminal and method for improving user convenience using a light unit. The mobile communication terminal controls the light unit such that a user can conveniently identify whether a predetermined operation or event occurs, and can easily identify an active key according to the current operation or event state. Accordingly, the user can easily perform a key input according to the current operation or event state.

### PRIORITY

This application claims priority to an application entitled “MOBILE COMMUNICATION TERMINAL AND METHOD FOR IMPROVING USER CONVENIENCE USING A LIGHT UNIT”, filed in the Korean Intellectual Property Office on Dec. 22, 2004 and assigned Serial No. 2004-110742, the entire contents of which are incorporated herein by reference.

### BACKGROUND OF THE INVENTION

1. Field of the Invention

The present invention relates generally to a mobile communication terminal, and more particularly to a mobile communication terminal and method for improving user convenience using a light unit.

2. Description of the Related Art

Generally, a mobile communication terminal includes a keypad, and responds to an input signal of a key that a user selects through the keypad. When the user presses the key through the keypad, the mobile communication terminal emits light from a light emitting diode (LED) unit of the keypad such that the user can easily identify and press the key.

FIG. 1 illustrates the arrangement of LEDs on a keypad in a conventional mobile communication terminal, and FIG. 2 is a block diagram illustrating the mobile communication terminal for controlling an LED unit of the keypad of FIG. 1.

Referring to FIG. 1, the mobile communication terminal includes a keypad 40 for enabling the user to input a key 20. The keypad 40 includes a pad from which a plurality of keys 20 protrude, and a base plate disposed below the pad. The base plate includes a dome for generating an electric signal when a key 20 is pressed. The keypad 40 includes the LED unit composed of a plurality of LEDs 10. Conventionally, the LEDs 10 mounted to the base plate illuminate the keypad 40 in the same color. Referring to FIG. 2, when a folder of a folder type mobile communication terminal is open, a control unit 30 turns on a keypad LED unit 50. When the folder is closed, the control unit 30 turns off the keypad LED unit 50. As mentioned above, the keypad LED unit of the conventional mobile communication terminal is turned on to illuminate the keypad in a single color.

A need for improving users' convenience in the mobile communication terminal is increasing. To meet this need, a user interface of the mobile communication terminal is configured such that the user can easily identify the user interface. However, because the conventional mobile communication only turns on/off a keypad LED unit during keypad use, it may not meet the need of the users.

### SUMMARY OF THE INVENTION

Therefore, it is an aspect of the present invention to provide a mobile communication terminal and method that improve user convenience using a light unit.

The above and other aspects of the present invention can be accomplished by a mobile communication terminal with a keypad, including a light unit having a plurality of light elements arranged corresponding to a plurality of keys of the keypad, a light driver for driving the light unit to emit light, and a control unit for controlling the light unit through the light driver such that a user can easily identify an active key (i.e. key to be activated) on the keypad when any one of a predetermined operation and event occurs.

The above and other aspects of the present invention can be accomplished by a method for emitting light in a mobile communication terminal, the mobile communication terminal including a keypad and a light unit with a plurality of light elements arranged corresponding to a plurality of keys of the keypad, the method including the steps of determining whether a predetermined operation and event occurs, and emitting light from the light unit when the predetermined operation and event occurs such that a user can easily identify an active key on the keypad.

### BRIEF DESCRIPTION OF THE DRAWINGS

The above and other aspects and advantages of the present invention will be more clearly understood from the following detailed description taken in conjunction with the accompanying drawings, in which:

FIG. 1 is a front functional view of a keypad illustrating the arrangement of light emitting diodes (LEDs) on a keypad in a conventional mobile communication terminal;

FIG. 2 is a block diagram illustrating the mobile communication terminal for controlling an LED unit of the keypad of FIG. 1;

FIG. 3 is a block diagram illustrating a mobile communication terminal in accordance with an embodiment of the present invention;

FIG. 4 is a front functional view of a keypad illustrating the arrangement of LEDs on a keypad in accordance with an embodiment of the present invention;

FIG. 5 is a control flow chart illustrating a procedure for controlling an LED unit of the mobile communication terminal in accordance with a first embodiment of the present invention;

FIG. 6 is a front functional view of a mobile communication terminal illustrating an operating state of the LED unit when it is controlled in the mobile communication terminal in accordance with the first embodiment of the present invention;

FIG. 7 is a control flow chart illustrating a procedure for controlling the LED unit of the mobile communication terminal in accordance with a second embodiment of the present invention;

FIG. 8 is a front functional view of a mobile communication terminal illustrating an operating state of the LED unit when it is controlled in the mobile communication terminal in accordance with the second embodiment of the present invention;

FIG. 9 is a control flow chart illustrating a procedure by which a user edits an LED pattern in the mobile communication terminal in accordance with an embodiment of the present invention;

FIG. 10 is a control flow chart illustrating a procedure for setting the LED pattern according to an event in accordance with an embodiment of the present invention;

FIG. 11 is a control flow chart illustrating a procedure for controlling the LED unit of the mobile communication terminal in accordance with a third embodiment of the present invention; and

FIG. 12 is a front functional view of a keypad illustrating an example of emitting light from the LED unit of the mobile communication terminal in accordance with an embodiment of the present invention.

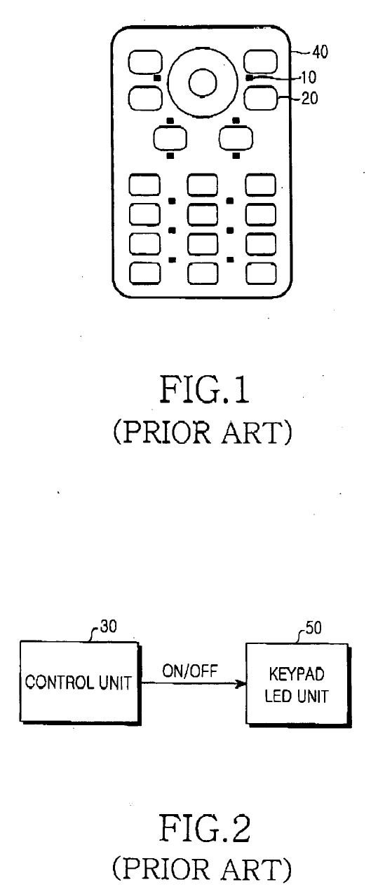

### DETAILED DESCRIPTION OF THE PREFERRED EMBODIMENTS

Preferred embodiments of the present invention will be described in detail herein below with reference to the accompanying drawings. In the following description, a detailed description of known functions and configurations incorporated herein will be omitted when it may make the subject matter of the present invention unclear.

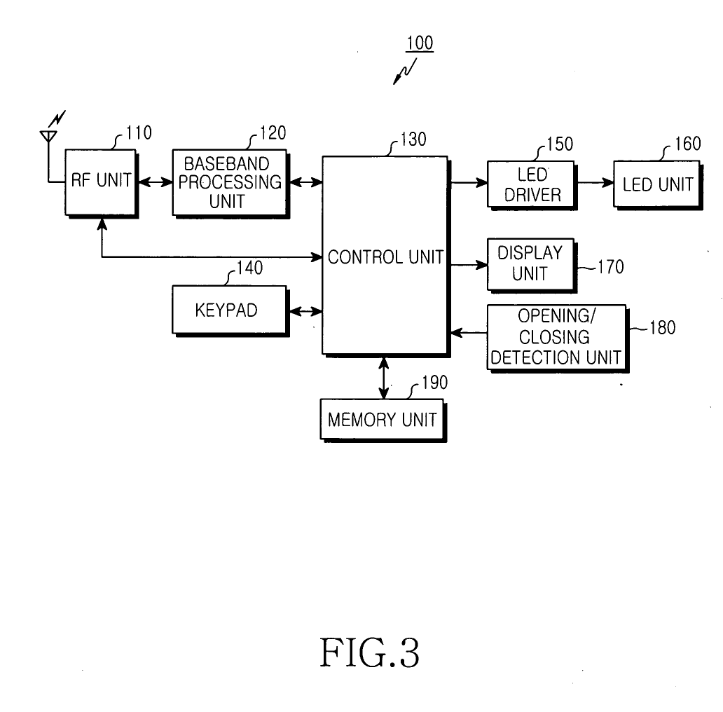

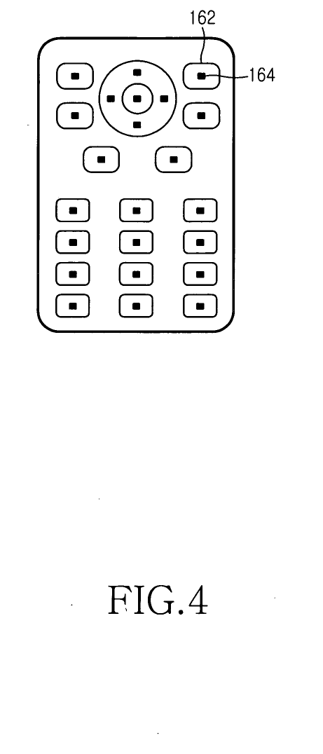

FIG. 3 is a block diagram illustrating a mobile communication terminal 100 in accordance with an embodiment of the present invention, and FIG. 4 illustrates the arrangement of light emitting diodes (LEDs) serving as light elements on a keypad in accordance with an embodiment of the present invention.

Referring to FIG. 3, the mobile communication terminal 100 includes a radio frequency (RF) unit 110, a baseband processing unit 120, a control unit 130, a keypad 140 serving as a user interface (UI), an LED driver 150 serving as a light driver, an LED unit 160 serving as a light unit, a display unit 170, an opening/closing detection unit 180, and a memory unit 190.

The control unit 130 controls overall operation of the mobile communication terminal 100. When waiting for a user to input a key, the control unit 130 controls the LED driver 150 such that the user can easily identify a key activated in the mobile communication terminal 100. The LED driver 150 drives the LED unit 160 according to a control operation of the control unit 130. The LED unit 160 illuminates the keypad 140. The keypad 140 includes a plurality of numeric keys and a plurality of function keys. The keypad 140 outputs, to the control unit 130, key input data mapped to a key pressed by the user. In this embodiment, the keypad 140 and the LED unit 160 are separately implemented. However, those skilled in the art will appreciate that the LED unit 160 may be included in the keypad 140.

Referring to FIG. 4, the LED unit 160 includes a plurality of multicolor LEDs 164. The multicolor LEDs 164 are arranged corresponding to respective keys 162. The multicolor LEDs 164 emit light in at least two colors according to a drive operation of the LED driver 150.

In accordance with a first embodiment of the present invention, the control unit 130 performs a control operation such that a display color of a soft key is the same as a light color of an LED mapped thereto when the soft key is displayed on the display unit 170. A soft key is a key located at upper part of keypad corresponding to the key displayed at lower part on the screen.

Alternatively, the control unit 130 controls the LED driver 150 such that a color of light illuminating the keypad key corresponding to the soft key is different from that of light illuminating other keypad keys. If the color of light illuminating the other keypad keys is the same as the display color of the soft key, the control unit 130 changes the color of light illuminating the other keypad keys or the display color of the soft key. In this case, the LED driver 150 can perform a drive operation such that the other keypad keys are illuminated in one color that is different from the display color of the soft key.

In accordance with a second embodiment of the present invention, the control unit 130 sets key map data mapped to a predetermined operation or event when a key input standby state occurs according to the predetermined operation or event. The key map data indicates an active or inactive state of each key based on the predetermined operation or event. When a key in the active state is pressed, the control unit 130 responds to input data of the pressed key. However, when a key in the inactive state is pressed, the control unit 130 does not respond to input data of the pressed key. The control unit 130 sets the key map data so that keys in the active state can be illuminated according to the predetermined operation. The control unit 130 refers to the key map data and controls the LED driver 150 such that only LEDs mapped to active keys emit light, and the light colors of the active keys is different from those of inactive keys. Accordingly, the user can easily distinguish the active keys from the inactive keys.

In accordance with a third embodiment of the present invention, the control unit 130 controls the LED driver 150 such that the LED unit 160 emits light in one color when a predetermined event or operation occurs, or emits light in another color when an event or operation state is changed. For example, the control unit 130 controls the LED driver 150 such that a light color in an incoming call reception mode is different from that in a call reply mode.

According to the above-described manner, the control unit 130 controls the LED driver 150 such that the LED unit 160 emits light in different colors according to operation or event states. The multicolor LEDs 164 of the LED unit 160 emit light in at least two colors according to a drive operation of the LED driver 150.

The control unit 130 enables the user to directly set a light color, character or pattern for a predetermined event. In this case, the control unit 130 provides the user with a user interface for deciding a light emitting style for the predetermined event. The user can decide a desired light color, character or pattern through the user interface provided by the control unit 130. The term “light color” is color of light emitted by the LED 164. The control unit 130 enables the user to set a light color for a corresponding LED 164 mapped to each key. The term “light character” is a character formed by light emitted from the LEDs 164. The control unit 130 forms key map data according to at least one light character of the user, and controls the LED driver 150 such that the LEDs 164 of the LED unit 160 can emit light on the basis of predetermined characters. For example, the controller 130 can control the LED unit 160 to form characters indicative of “CALL” in the incoming call reception mode.

The term “light pattern” is a shape of light emitted by the LED unit 160. The light pattern includes a pattern for flickering light, a pattern for dividing the LEDs 164 into several LED groups and sequentially emitting light from the LED groups in predetermined order, etc. The light color, character and pattern can be variously implemented. The present invention is not limited to the above-mentioned examples.

When a predetermined operation or event occurs, the control unit 130 controls the LED unit 160 through the LED driver 150 such that the user can conveniently identify a current operation or event state. Moreover, the control unit 130 can easily identify an active key according to the current operation or event state.

The memory unit 190 includes a read only memory (ROM) and a random access memory (RAM) for storing a plurality of programs necessary to control the operation of the mobile communication terminal 100. More specifically, the memory unit 190 stores key map data for controlling the LED unit 160, and a database (DB) for storing a light pattern defined by the user.

The RF unit 110 transmits an RF signal to and receives an RF signal from a base station through an antenna. The RF unit 110 converts the received RF signal into an intermediate frequency (IF) signal to output the IF signal to the baseband processing unit 120, and converts an IF signal input from the baseband processing unit 120 into an RF signal to transmit the RF signal. The baseband processing unit 120 serves as a baseband analog application specific integrated circuit (ASIC) for proving an interface between the control unit 130 and the RF unit 110. The baseband processing unit 120 converts a baseband digital signal applied from the control unit 130 into an IF signal to apply the IF signal to the RF unit 110, and converts an analog IF signal applied from the RF unit 110 into a baseband digital signal to apply the baseband digital signal to the control unit 130. The opening/closing detection unit 180 detects a state in which a folder is open or closed when the mobile communication terminal 100 is a folder type terminal, and applies detection information to the control unit 130. The display unit 170 receives display data based on key input data input from the keypad 140 and displays the received display data. Moreover, the display unit 170 displays an operating state of the mobile communication terminal and various types of information in the form of icons or characters according to a control operation of the control unit 130. As described above, the display unit 170 displays a soft key according to a predetermined function or event.

Now, methods for controlling the LED unit in the mobile communication terminal in accordance with preferred embodiments of the present invention will be described.

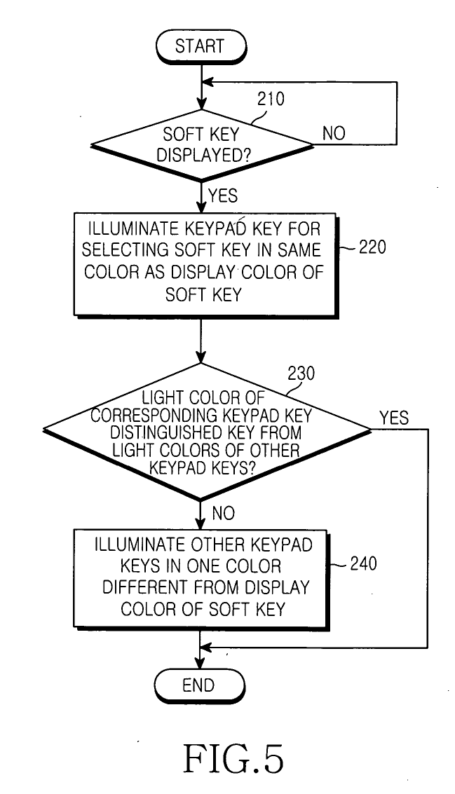

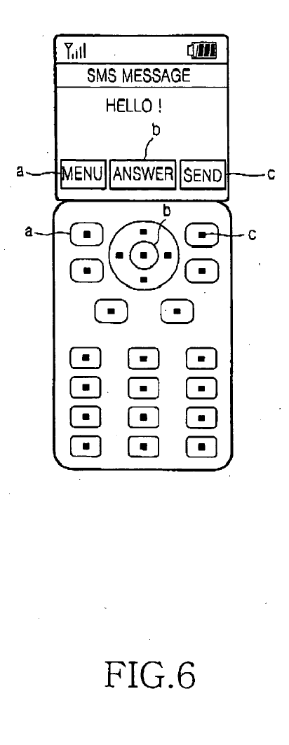

FIG. 5 is a control flow chart illustrating a procedure for controlling the LED unit of the mobile communication terminal in accordance with the first embodiment of the present invention, and FIG. 6 illustrates an operating state of the LED unit when it is controlled in the mobile communication terminal in accordance with the first embodiment of the present invention.

Referring to FIGS. 5 and 6, the control unit 130 determines whether a soft key is displayed in step 210. The control unit 130 can control the display unit 170 to display the soft key according to a predetermined function or event. If the soft key is displayed, the control unit 130 proceeds to step 220 to perform a control operation such that a light color of an LED 164 for illuminating a keypad key 162 for selecting the soft key is the same as a display color of the soft key. The control unit 130 controls a corresponding LED 164 through the LED driver 150 such that the keypad key for selecting the soft key is illuminated in the same color as that of the soft key. Referring to FIG. 6, the control unit 130 controls the display unit 170 to display three soft keys when receiving a short message service (SMS) message. Keypad keys for selecting the soft keys are illuminated in the same colors as display colors a, b, and c of the soft keys. Accordingly, the user can easily determine which keypad key needs to be used to select a corresponding soft key.

In step 230, the control unit 130 determines whether a color of light illuminating a keypad key corresponding to a soft key is the same as that of light illuminating other keypad keys. If a display color of the soft key is the same as the color of light illuminating the other keypad keys, the control unit 130 proceeds to step 240 to control the LEDs 164 mapped to the other keypad keys through the LED driver 150 such that they emit light in a color different from the display color of the soft key. However, if the display color of the soft key is not the same as the color of light illuminating the other keypad keys, the process ends.

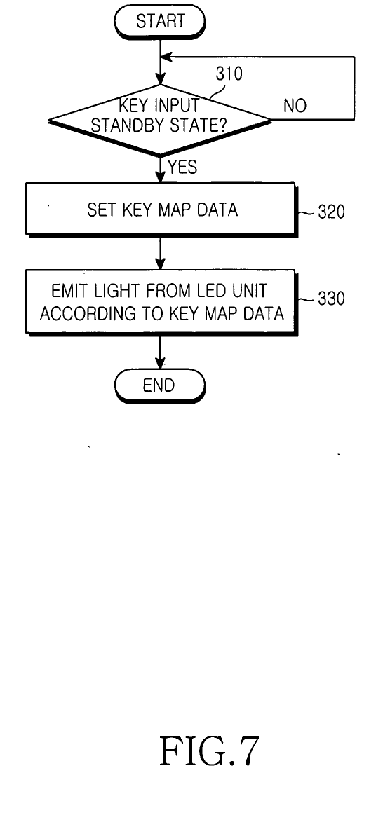

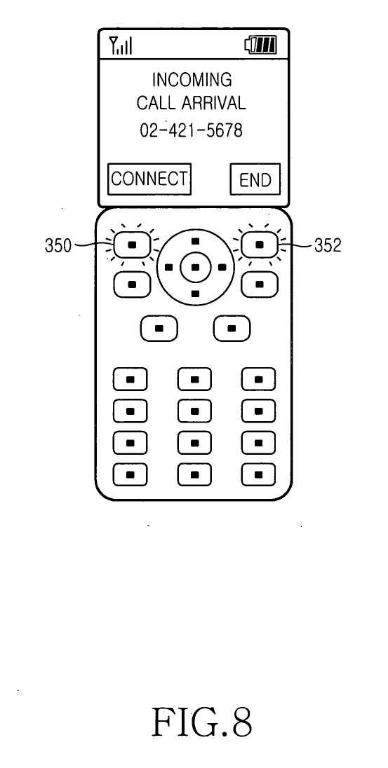

FIG. 7 is a control flow chart illustrating a procedure for controlling the LED unit of the mobile communication terminal in accordance with the second embodiment of the present invention, and FIG. 8 illustrates an operating state of the LED unit when it is controlled in the mobile communication terminal in accordance with the second embodiment of the present invention.

Referring to FIGS. 7 and 8, the control unit 130 determines whether a key input standby state occurs according to a predetermined operation or event in step 310. Because the control unit 130 generally operates in response to a key input from the user, a case where the control unit 130 waits for user to input a key occurs frequently. When waiting for the user to input a key, the control unit 130 sets key map data based on a predetermined operation in step 320. The key map data indicates an active or inactive state of each key according to the predetermined operation. In step 330, the control unit 130 controls an LED 164 mapped to a key in the active state to emit light, such that the user can easily identify a key to be selected. Referring to FIG. 8, the control unit 130 receives, for example, a key capable of performing a call connection function or a key capable of performing a call termination function from the user, when an incoming call is received. The control unit 130 performs a control operation such that only LEDs 164 associated with corresponding keys emit light and keys capable of being selected by the user are displayed. Soft keys mapped to the call connection and termination keys are illustrated in FIG. 8. When no soft key is displayed, the control unit 130 can perform a control operation such that LEDs 164 mapped to active keys can emit light in the key input standby state.

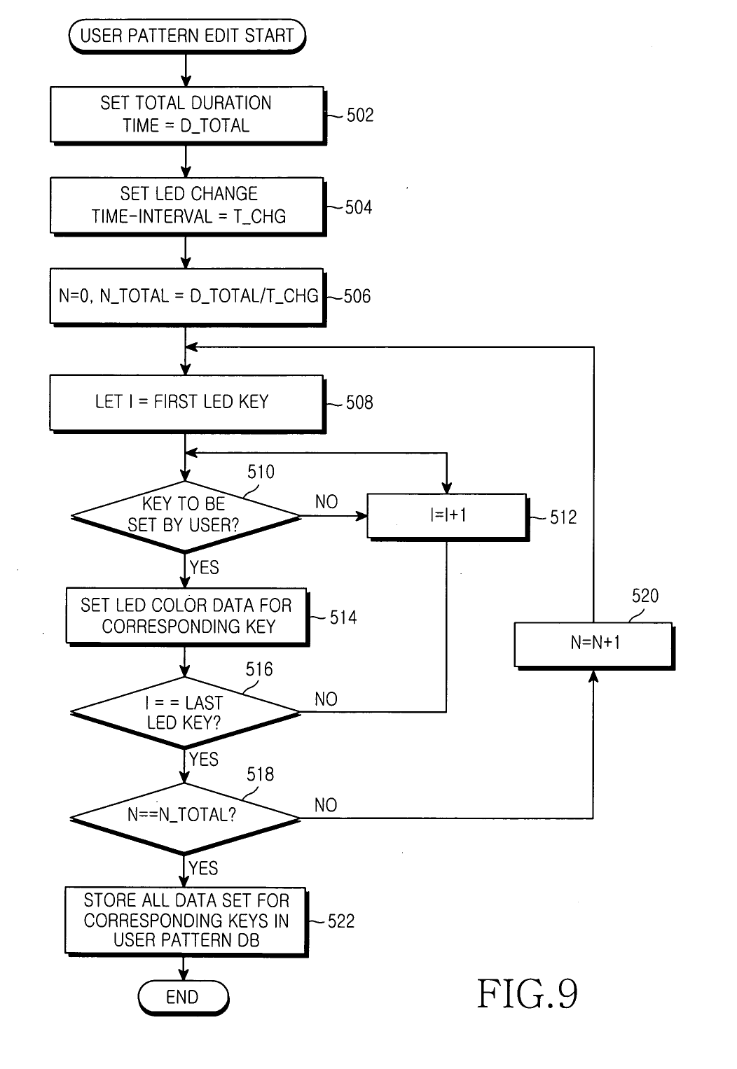

FIG. 9 is a control flow chart illustrating a procedure by which the user edits an LED pattern in the mobile communication terminal in accordance with an embodiment of the present invention.

Referring to FIG. 9, the control unit 130 receives a total light duration time from the user when entering a user pattern mode in step 502. Subsequently, the control unit 130 receives an LED change time-interval from the user in step 504. The LED change time-interval is a time interval for changing a predetermined LED pattern or color. The control unit 130 computes the total number of light emitting times in step 506 and then proceeds to step 508. The total number of light emitting times N is computed by dividing the total light duration time by the LED change time-interval.

The control unit 130 set a first key for LED setup in step 508, and then proceeds to step 510. The control unit 130 determines whether the user makes an LED setup operation for a corresponding key in step 510. If the corresponding key is not selected, the control unit 130 proceeds to a next key for LED setup in step 512 to increase the number of the first key for LED setup by one.

If the user selects the LED setup for a corresponding key, the control unit 130 receives information of a light color for the corresponding key from the user and configures light color data in step 514. Then, the control unit 130 proceeds to step 516 to determine whether a corresponding key is the last key for LED setup. If a corresponding key is not the last key for LED setup, the control unit 130 proceeds to another next key in step 512. The user may arbitrarily select a key for LED setup.

However, if a corresponding key is the last key for LED setup, the control unit 130 proceeds to step 518 to determine whether the current number of light emitting times is N. If the current number of light emitting times is N, the control unit 130 proceeds to step 522 to store, in the DB, all LED setup data mapped to the respective keys according to a user pattern. If the current number of light emitting times is less than N at step 518, the control unit 130 proceeds to step 520 to increase the number of light emitting times by one. Then, the control unit 130 proceeds to step 508. Now, a case where the user sets a user pattern or default pattern according to an event will be described.

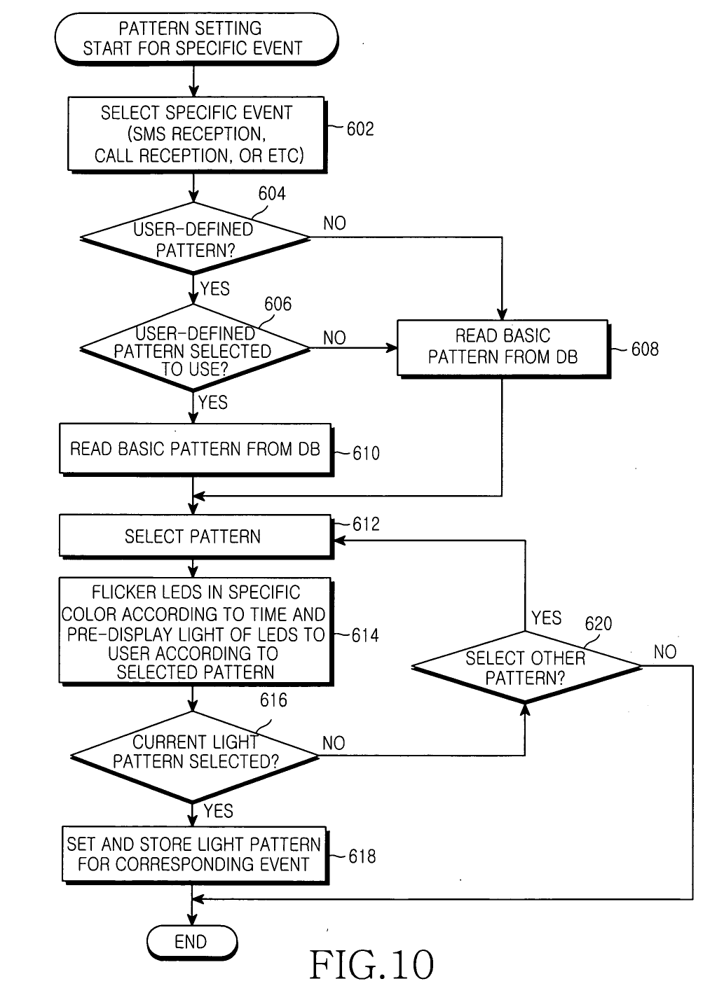

FIG. 10 is a control flow chart illustrating a procedure for setting an LED pattern according to an event in accordance with an embodiment of the present invention.

Referring to FIG. 10, the control unit 130 receives a specific event selected by the user when an operating mode for setting an LED pattern based on a predetermined event is entered in step 602. Here, the predetermined event can be, for example, a folder opening, incoming call reception, SMS message reception or alarm generation event. Subsequently, the control unit 130 determines whether a user-defined pattern stored by the user is present in the DB in step 604. If a user-defined pattern is not present, the control unit 130 proceeds to step 608. If a user-defined pattern is stored in the DB, the control unit 130 determines whether the user selects the user-defined pattern in step 606. If the user does not select using the user-defined pattern, the control unit 130 proceeds to step 608 to read a default pattern, that is, a kind of basic pattern, stored in the DB. Then, the control unit 130 proceeds to step 612. However, if the user selects the user-defined pattern, the control unit 130 proceeds to step 610 to read the user-defined pattern from the DB. Then, the control unit 130 proceeds to step 612. In step 612, the control unit 130 receives a predetermined pattern selected by the user. The control unit 130 performs a control operation such that a user-defined pattern item and a basic pattern item are displayed on a screen, and types of pattern based on the item selected by the user are displayed. Accordingly, the user can select a predetermined pattern. The control unit 130 flickers the LEDs 164 in a specific color according to time, and pre-displays light of the LED unit 160 to the user according to the selected pattern in step 614. Subsequently, the control unit 130 determines whether the user selects a current light pattern in step 616. If the user does not select the current light pattern, the control unit 130 proceeds to step 620 to determine whether the user selects another pattern. If the user selects another pattern, the control unit 130 proceeds to step 612. However, if the user does not select another pattern, the control unit 130 terminates corresponding control flow. If the user selects the current light pattern, the control unit 130 proceeds to step 618 to set a light pattern selected for a corresponding event.

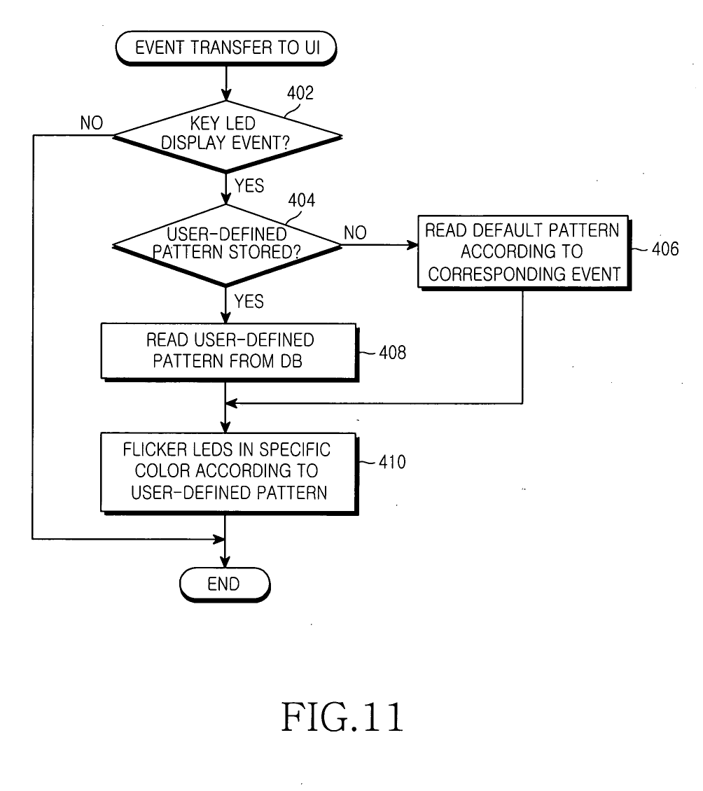

Control flow for emitting light from the LED unit 160 according to the light pattern set for a predetermined event will be described with reference to FIG. 11.

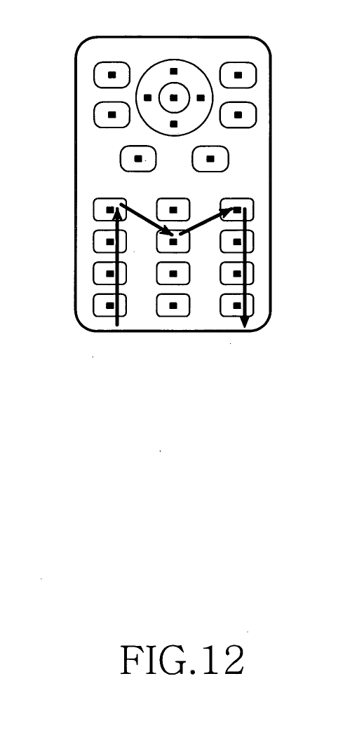

FIG. 11 is a control flow chart illustrating a procedure for controlling the LED unit of the mobile communication terminal in accordance with the third embodiment of the present invention, and FIG. 12 illustrates an example of emitting light from the LED unit of the mobile communication terminal in accordance with an embodiment of the present invention.

Referring to FIG. 11, the control unit 130 determines whether a key LED display function is set when a predetermined event occurs in step 402. The user can set the key LED display function associated with each event. If the key LED display function for the predetermined event is set, the control unit 130 proceeds to step 404 to determine whether a user-defined pattern is present. However, if the key LED display function for the predetermined event is not set, the control unit 130 terminates the process. A light pattern based on the key LED display function can be set by the user as illustrated in FIG. 9 or can be set to the default pattern by a manufacturer when the terminal is manufactured. The control unit 130 determines whether a light pattern for a corresponding event is set by the user in step 404. If a user-defined pattern for a corresponding event is absent, the control unit 130 reads the default pattern based on the corresponding event in step 406, and then proceeds to step 410. However, if the user-defined pattern for the corresponding event is present, the control unit 130 reads the user-defined pattern from the DB in step 408 and then proceeds to step 410. The control unit 130 controls the LED 164 of each key to emit light in a set color according to the light pattern in step 410. Accordingly, the LEDs 164 emits light such as according to a predetermined pattern as illustrated in FIG. 12.

As described above, the present invention enables the user to easily identify the current operation or event state or an active key by controlling the light unit when the predetermined operation or event occurs. Accordingly, the user can easily perform a key input according to the predetermined operation or event.

Although preferred embodiments of the present invention have been disclosed for illustrative purposes, those skilled in the art will appreciate that various modifications, additions and substitutions are possible, without departing from the sprit and scope of the present invention as defined by the appended claims.

What is claimed is:

1. A mobile communication terminal with a keypad, comprising:
a light unit having a plurality of light elements arranged corresponding to a plurality of keys of the keypad;
a light driver for driving the light unit to emit light; and
a control unit for controlling the light unit through the light driver,
wherein a user easily identifies an active key on the keypad when a predetermined operation and event occurs.

2. The mobile communication terminal according to claim 1, wherein the control unit controls the light unit through the light driver when a soft key is displayed,
wherein a light element of a keypad key corresponding to the soft key emits light in the same color as a display color of the soft key.

3. The mobile communication terminal according to claim 1, wherein the control unit controls the light unit through the light driver when at least two soft keys are displayed, wherein keypad keys corresponding to the displayed soft keys are illuminated in different light colors.

4. The mobile communication terminal according to claim 2, wherein the control unit controls the light unit through the light driver,
wherein a color of light illuminating the keypad key corresponding to the soft key is different from a color of light illuminating other remaining keypad keys.

5. The mobile communication terminal according to claim 1, wherein the control unit controls at least one light element to emit light through the light driver when the predetermined operation and event occurs, the at least one light element being mapped to at least one active key arranged on the keypad.

6. The mobile communication terminal according to claim 5, wherein the control unit sets key map data being indicative of an active or inactive state of each key arranged on the keypad, the key map data being mapped to one of the predetermined operation and event.

7. The mobile communication terminal according to claim 1, wherein the control unit controls the light unit to emit light in one color when the predetermined operation and event occurs, and controls the light unit to emit light in another color when an operation or event state is changed.

8. The mobile communication terminal according to claim 1, wherein the control unit receives a light pattern set according to one of the predetermined operation and event.

9. The mobile communication terminal according to claim 8, wherein the control unit controls the light unit through the light driver according to the light pattern when the predetermined operation and event occurs.

10. The mobile communication terminal according to claim 8, wherein the light pattern has at least one of light patterns being indicative of a color of light emitted from the light unit, a character formed by light emitted from the light unit, and a shape of light emitted from the light unit.

11. A method for emitting light in a mobile communication terminal, the mobile communication terminal including a keypad and a light unit with a plurality of light elements arranged corresponding to a plurality of keys of the keypad, the method comprising:
determining whether a predetermined operation and event occurs; and
emitting light from the light unit when the predetermined operation and event occurs.

12. The method according to claim 11, further comprising:
emitting light from a light element of a keypad key corresponding to a soft key in the same color as a display color of the soft key when the soft key is displayed during the predetermined operation or event.

13. The method according to claim 12, further comprising:
emitting light from the light unit when at least two soft keys are displayed,
wherein keypad keys corresponding to the displayed soft keys are illuminated in different light colors.

14. The method according to claim 12, further comprising:
emitting light from the light unit,
wherein a color of light illuminating the keypad key corresponding to the soft key is different from a color of light illuminating other remaining keypad keys.

15. The method according to claim 11, further comprising:
emitting light from at least one light element mapped to at least one active key arranged on the keypad when the predetermined operation and event occurs.

16. The method according to claim 15, further comprising:
setting key map data being indicative of an active or inactive state of each key arranged on the keypad, the key map data being mapped to one of the predetermined operation and event.

17. The method according to claim 11, further comprising:
controlling the light unit to emit light in one color when the predetermined operation and event occurs; and
controlling the light unit to emit light in another color when an operation or event state is changed.

18. A method for emitting light in a mobile communication terminal, the mobile communication terminal including a keypad and a light unit with a plurality of light elements arranged corresponding to a plurality of keys of the keypad, the method comprising:
receiving a light pattern set according to one of predetermined operation and event;
determining whether a predetermined operation and event occurs; and
emitting light from the light unit according to the light pattern when the predetermined operation and event occurs.

19. The method according to claim 18, wherein the light pattern has at least one of light patterns being indicative of a color of light emitted from the light unit, a character formed by light emitted from the light unit, and a shape of light emitted from the light unit.
